(19) United States
(12) Patent Application Publication
(10) Pub. No.: US 2007/0208602 A1
(43) Pub. Date: Sep. 6, 2007

(54) SYSTEM AND METHOD FOR PROVISIONING WORKFLOW-ENHANCED BUNDLES OF COMPUTING RESOURCES

(76) Inventors: David Nocera, Martinsville, NJ (US); Darren Suprina, Edison, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/681,623

(22) Filed: Mar. 2, 2007

Related U.S. Application Data
(60) Provisional application No. 60/778,352, filed on Mar. 2, 2006.

(51) Int. Cl. G05B 19/418

(52) U.S. Cl. 705/8

(57) ABSTRACT

A system and method for provisioning a user with one or more related computing resources (e.g., applications, content, and/or services) which are collected into a bundle. The bundled computing resources are directed to the performance of one or more tasks. In addition, one or more workflows may be established and associated with the bundle to guide the user in his or her interaction with the bundle and computing resources contained therein. A user profile may be established which includes information related to a specific user. The user profile may be associated with the one or more bundles, and used to govern the user's interaction with the bundle(s). The present invention also includes a centralized search engine which allows a user and/or third party provider of computing resources or bundles to search for and locate a workflow, user profile, task profile, and/or bundle.

### CROSS REFERENCE TO RELATED APPLICATION

This application claims the benefit of U.S. Provisional Application Ser. No. 60/778,352 filed on Mar. 2, 2006. The entire disclosure of U.S. Provisional Application Ser. No. 60/778,352 is incorporated by reference herein.

### FIELD OF THE INVENTION

The present invention relates generally to a method and system for provisioning one or more users with computing services, and specifically to bundling a plurality of related services including an associated workflow(s), a centralized search engine, and/or a user management module.

### BACKGROUND OF THE INVENTION

Conventionally, users of computing systems utilize a graphical user interface (GUI) to interface with iconic representations of applications, data and other resources. A variety of techniques have been devised to obtain, gain access to, collect, and organize these iconic representations.

Generally, a user may collect one or more software packages for use on his or her computing system. These packages may include one or more applications, content, and/or services (collectively referred to as a “resource” or “resources”) which may be searched for and located using conventional Internet-based search engines. The resources may then be downloaded, installed, referenced, subscribed to, and/or purchased by the user. Each acquired resource may be placed into one or more of GUT containers, such as a computing system's “desktop”, a menu-based system, and/or a directory.

However, the above method of collection and management of resources includes a number limitations which limit efficiency and utility. For example, each resource, whether installed on a local system by a user or referenced and accessed from a remote location residing on a network (i.e., the Internet), remains separate and distinct, and lacks an association with other resources. As such, resources having a logical relationship to one another are not linked or associated within the computing system, other then their residence in a common container.

Conventional computing systems lack a means by a newly acquired resource can be associated with an existing resource to which it is related. For example, in a typical computing environment, if a user contracts for a service (e.g., customer support) related to an existing application (e.g., a software program), there is no way to represent the two resources as peers. Instead, conventional systems support the representation of the service as a website or application to be launched, separate and distinct from the other related resource(s).

In addition, conventional computing systems provide no vehicle by which a workflow may be associated to a related resource (i.e., a peer) or collection of resources. As known in the art, a “workflow” includes, but is not limited to a structuring of tasks organized to produce a final outcome. Furthermore, known computing methods and systems are unable to use a workflow to: 1) direct or drive the presentation and/or interaction of resources grouped together, herein referred to as a “bundle”; 2) manage access to the resources of a bundle; and/or 3) invoke, change the state of, or terminate the use of a resource of a bundle.

Moreover, conventional methods and systems lack a means by which information about a user (e.g., personal, financial, and preference data), herein referred to as “user data,” may be centrally stored and disseminated to one or more third party providers of resources in a fashion that is both third party-provider neutral and which may be configured by the user to support the release of that data, upon approval, to one or more specific third parties in an automated and controlled manner.

Furthermore, traditional computing methods and systems lack a means by which the user data or a method for gathering necessary user data may be associated with one or more resources or bundles. In addition, known systems and methods further lack a means for a workflow to “draw” or use centralized user data to: 1) initialize the state of a workflow; 2) change/update the state of a workflow; 3) report the state of a workflow; and/or 4) terminate a workflow.

Finally, typical computing systems are not able to provide centralized user data which can be utilized to provide authentication and/or authorization to facilitate a user's ability to subscribe to and use a resource and/or bundle.

Accordingly, there is a need in the art for a method and system for provisioning a collection of computing resources (i.e., a bundle) to a user, wherein the bundle is associated with user data, and wherein the bundles is associated with one or more related workflows. In addition, there is a need in the art for a method and system permit workflows to be defined, offered, searched, subscribed to, and/or accessed by a user based on the user's preferences.

### SUMMARY OF THE INVENTION

The above-described problems are addressed and a technical solution is achieved in the art by a computing system and a method for presenting, and provisioning a plurality of associated computing resources (e.g., applications, content, services, workflows, etc.) into a bundle. The present invention provides for a bundle directed to the execution of one or more tasks to be further enhanced by the addition of one or more workflows and/or user profile data, as well as through the introduction of centralized services such as profile data storage and distribution, user identity management, and financial clearinghouse services.

According to an embodiment of the present invention, the bundle may be associated with or configured to include one or more related workflows and user profile data to provide a more logical presentation and accessibility to the user.

According to an embodiment of the present invention, the system and method provides for a workflow manager configured to establish and manage one or more workflows. The workflow(s) are designed to suggest, guide, direct, manage, mandate and/or govern a user in performing one or more tasks, in accordance to predefined sequence(s) of steps and/or events. Advantageously, the workflow manager may configure the workflows like a conventional computing ‘object,’ which may be defined, offered, searched for, rated, reviewed, subscribed to, accessed, utilized, downloaded, grouped, and/or included in one or more bundles. Advantageously, the one or more workflows may be utilized either as a group (i.e., a workflow bundle) or individually.

Furthermore, the workflow manager may permit access or reference to specific content of a workflow, and further have the ability to initiate and use services offered by one or more third parties (e.g., resource providers).

According to an embodiment of the present invention, one or more task profiles may be established which includes a collection of information related to a specific topic and/or task. A task profile includes, but is not limited to, data related to one or more tasks which are, or may be, part of any workflow of a bundle. Such data may be of fixed value, be calculation intermediaries of a task or workflow, or reference external data sources and/or storage. The present invention includes a task profile manager configured to manage the task profiles as “objects,” such that the task profiles may be searched for, included in bundles, accessed, utilized, downloaded, stored and managed remotely, and/or subscribed to, in a fashion similar to the means by which conventional applications, content, and services are managed. The task profile manager supports multiple classifications and controls over the release of information contained therein, including but not limited to an automated release, release on approval, release after redaction, deny release, and deny release with cause.

According to an embodiment of the present invention, the systems and methods provide for the management of the contents of profiles in a fashion that supports multiple classifications and controls over the release of information contained therein, including but not limited to automated release, release on approval, release after redaction, deny release, and deny release with cause. Such information is referred to as a task profile, of which there may be multiple distinct instances associated with each task, and used in support of any workflow associated with a bundle. The task profile is configured to be defined, offered, searched for, subscribed to, grouped, and/or included in one or more bundles. Further, the task profile may be accessed, utilized, downloaded, stored and/or managed remotely, in a fashion similar to a conventional applications, content, and/or services (e.g., computing resource).

According to an embodiment of the present invention, the system and method allow a user to establish an “user profile” which includes information related to the user. The user profile may be used to support authentication and authorization services required to access and utilize computing resources and/or bundles.

Advantageously, the user profiles may be treated like “objects” which can be searched for and otherwise grouped with and treated like conventional computing resources. Furthermore, the system and method provides for the centralized management of user profiles by an identity manager, wherein users are able to manage his or her user profile by controlling the data contained therein, and the level of access to the user profile by the user and one or more third parties (i.e., computing resource providers).

According to an embodiment of the present invention, the systems and methods provide for a bundle manager configured to establish and manage one or more bundles (i.e., collections of related computing resources). The system and method allow for one or more workflows, task profiles, and/or user profiles to be associated with or added to a related bundle. In addition, the bundle manager interacts with the identity manager (i.e., component which manages the one or more user profiles) to manage a user's requirements for privacy (of data and usage), identity (verification), and non-refutability (of access and actions).

The bundle manager is communicatively connected to the workflow manager and configured to associate one or more workflows with a related bundle such that the workflow nay be used to suggest, guide, direct, and/or govern a user's interaction with the bundle. For example, the workflow may provide the user with a step-by-step guide detailing the sequence of events for the user's navigation of a bundle and/or interactions with computing resources of the bundle.

According to an embodiment of the present invention, the bundle manager is configured to refer to and use a user profile to support the user's requirements for privacy (of data and usage), identity (verification), and non-refutability (of access and actions).

According to an embodiment of the present invention, the systems and methods provide for a payment manager configured to act as a clearinghouse for all monetary and non-monetary credits and debits that arise as a result of a user's use of any aspect of the bundles and/or workflows, including but not limited to search, subscription, usage, and the supply or consumption of resources (computational, storage, data transfer, telephony, human attention, etc.) as a result of such activities. The payment manager further provides for the centralized management of financial transactions in support of the search for and subscription to bundles, computing resources, workflows, user profiles, and/or task profiles.

According to an embodiment of the present invention, a search engine is provided and communicatively connected to the bundle manager, workflow manager, identity manager, and task profile manager. The search engine is configured to allow one or more users and/or third party providers to search for a workflow, bundle, computing resource, task profile, user profile, and/or a combination thereof

According to an embodiment of the present invention, the bundle manager and workflow manager interact with one another to track the user's actions, inactions, or the actions of events related to a user's interaction with a bundle or computing resource within a bundle, or the occurrence of an external evens to which a sensitivity has been established, to trigger an appropriate workflow(s) to start, change state, report on their state, take action, or terminate. Advantageously, the workflows are configured to affect what portion of a bundle is presented to a user and/or how a bundle is presented to the user, based on the user's interaction with the bundle in this regard, some or all of a bundle's computing resources and interactions therewith may be managed and guided by a workflow which is integrated into the bundle.

The workflow manager and identity manager interact with one another to allow a workflow to be driven by a user profile. For example, the user profile may dictate how the workflow is performed by constraining or governing the workflow based on the information of the user profile, such as, for example, a user's requirements related to access to his or her information by a third party, user preferences, user payment information, etc.

The provisioning system of the present invention may further comprise a payment manager configured to facilitate the financial services related to use of the provisioning system. For example, the payment manager may establish a financial arrangement with a single service to act as a clearinghouse for all monetary and non-monetary credits and debits that arise as a result of a user's use of any aspect of the provisioning system, including but not limited to search, subscription, usage, and the supply or consumption of resources (computational, storage, data transfer, telephony, human attention, etc.) as a result of such activities.

### BRIEF DESCRIPTION OF THE DRAWINGS

The present invention will be more readily understood from the detailed description of preferred embodiments presented below considered in conjunction with the attached drawings, of which:

FIG. 1 is an illustration of a Computing Resource Provisioning System, according to an embodiment of the present invention;

FIGS. 2 is an illustration of an exemplary user interface of the Computing Resource Provisioning System wherein a plurality of bundles are presented to the user, according to an embodiment of the present invention;

FIG. 3 illustrates a user interface displaying an exemplary bundle, according to an embodiment of the present invention;

FIG. 4 illustrates a user interface displaying an exemplary user profile, according to an embodiment of the present invention; and

FIG. 5 illustrates a user interface displaying a workflow-enhanced bundle, according to an embodiment of the present invention.

It is to be understood that these figures are for purposes of illustrating the concepts of the invention and may not be to scale, and that the organization of graphical elements or their particular presentation in any fashion, including but not limited to type, placement, orientation, presentation, or interactivity are intentionally unbounded and left open to bundle authorship creativity.

### DETAILED DESCRIPTION OF THE INVENTION

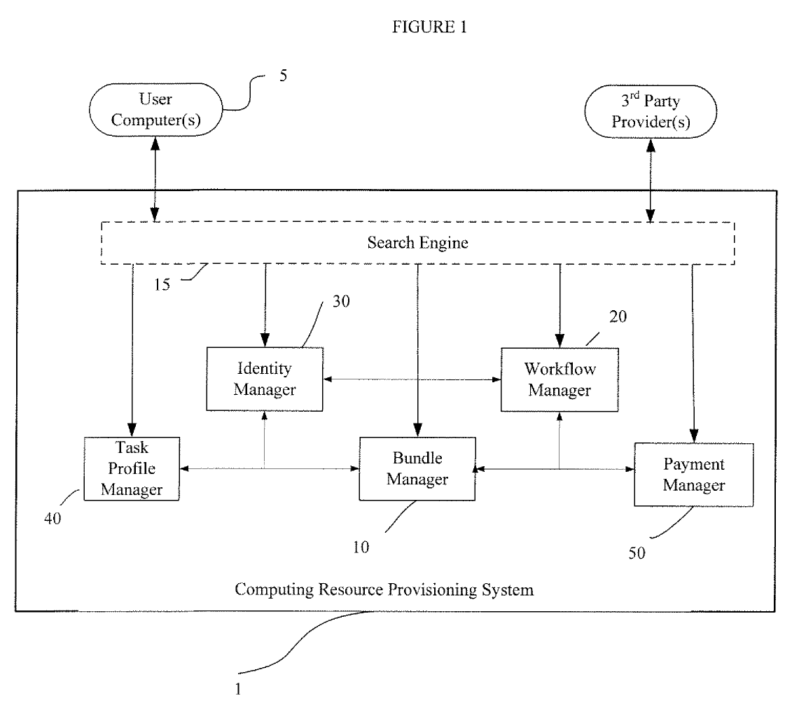

FIG. 1 depicts a Computing Resource Provisioning System 1 (herein the “Provisioning System”), according to embodiments of the present invention. It is to be understood that the schematic representation of the Provisioning System 1 provided in FIG. 1 is exemplary in nature and alternative arrangements are within the scope of the present invention.

According to an embodiment of the present invention, the Provisioning System 1 is a computer-based system, accessible by one or more communicatively connected users seeking to access and interface with one or more computer-based applications, content, services and/or workflows, collectively referred to herein as “computing resources.” The term “computer” is intended to include any data processing device, such as a desktop computer, a laptop computer, a mainframe computer, a personal digital assistant, a server, or any other device able to process data. The term “communicatively connected” is intended to include any type of connection, whether wired or wireless, in which data may be communicated. The term “communicatively connected” is intended to include a connection between devices and/or programs within a single computer or between devices and/or programs on separate computers.

According to an embodiment of the present invention, the systems and methods provide for related computing services to be aggregated into one or more bundles. The bundles may be enhanced by associating them with one or more related workflows, which may be created and offered by the Provisioning System 1 and/or one or more third party providers.

The term “third party provider,” as used herein, includes but is not limited to any third party (individual or entity) which provides one or more computer applications, content, services, and/or workflows (i.e., computing resources).

The Provisioning System 1 includes, but is not limited to the following components: a Bundle Manager 10, a Search Engine 15, a Workflow Manager 20, an Identity Manager 30, a Task Profile Manager 40, and a Payment Manager 50 One having ordinary skill in the art will appreciate that the components of the Provisioning System 1 may be located on a single computer, as schematically illustrated in FIG. 1, or on more than one communicatively connected computers. The Provisioning System 1 and the components thereof perform a number of functions, as described in detail below, which may be executed, implemented, supervised, monitored, and/or managed by a computer (i.e., hardware and/or software), one or more persons, and/or a combination of both.

A user may access the Provisioning System 1 using a computer, herein referred to as a User Computer 5. According to an embodiment of the present invention, the User Computer 5 includes a Web browser that provides access to one or more Web-based networks, such as, for example, the Internet. One having ordinary skill in the art will appreciate that any suitable Web browser may be used in accordance with the present invention, including but not limited to FireFox, Microsoft® Internet Explorer, Netscape, Opera, WebTV®, and Mozilla™. Alternatively, an application specifically designed to support the service may be used in place of a web browser, and may be distributed for execution on the User Computer 5 using any existing technique for such distributions.

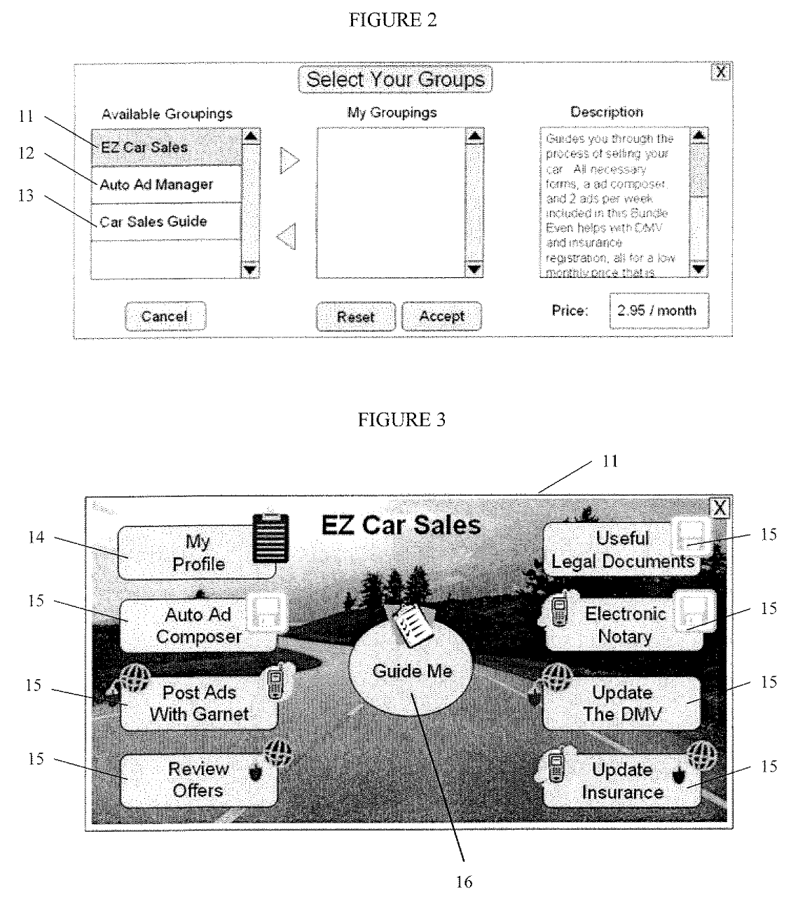

The Bundle Manager 10 is a computer-executable module configured to aggregate one or more related computing resources. Computing resources are related if they are associated with the performance or execution of one or more tasks. The term “task,” as used herein, includes but is not limited to any function, job, action, process, method, or topic. For example, in FIG. 2, the exemplary bundle titled “EZ Car Sales” 11 relates to the task of selling a vehicle.

Advantageously, the Bundle Manager 10 is configured to present the one or more computing resources in a unified manner (i.e., a bundle) to the User Computer 5 via a conventional GUI interface including one or more suitable icons. The one or more computing resources (e.g., applications, content, services, workflow) of the bundle may be presented as either a reference or invocation to a locally installed computing resource or a reference to run/execute a computing resource maintained by a remotely located computer (e.g., a third party provider's computer). Optionally, for remotely located computing resources, the Bundle Manager 10 may project or present the remote resource's GUI, if any, to the User Computer 5 for viewing and interaction therewith. Advantageously, the Bundle Manager 10 supervises, manages, and controls access to the computing resource in a manner which makes the location of the computing resources (i.e., local or remote) is transparent to the User Computer 5.

The Bundle Manager 10 may be configured to establish a plurality of bundles, wherein one or more of the computing resources may be shared by or included within a number of different bundles. According to embodiments of the present invention, the bundles may be created in the following ways: 1) the Bundle Manager 10 may create the bundle by aggregating a plurality of computing resources received from one or more third party providers; and/or 2) a third party provider (i.e., an aggregator or bundle builder) may create the bundles.

According to an embodiment of the present invention, the GUI presentation (i.e., the graphical and audio aspects of the user interface) of the one or more bundles and related computing resources may be manipulated, changed, altered, amended, updated, etc., by a third party provider of the bundle. In this regard, the audio-visual presentation and work environment experienced by the User Computer 5 may be under at least partial control of the bundle provider.

The Bundle Manager 10 may also provide for management of a support service component of a bundle (i.e., technical support), wherein the Bundle Manager 10 may be configured to schedule and/or establish contact between the User Computer 5 and a third party support representative, system, and/or service adapted to provide a user with assistance, advice, guidance, and direction related to the user's utilization of the bundle and/or computing resources contained therein.

As shown in FIG. 1, the Provisioning System 1 includes a Workflow Manager 20. The Workflow Manager 20 is a computer-executed program and/or hardware module configured to create and/or manage one or more workflows which provide a structured approach and/or method designed to assist, guide and direct the user in his or her performance of a task associated with one or more bundles or computing resources. Moreover, the workflows are designed to drive that is presented to the user and what is to be done. One having ordinary skill in the art will appreciate that the one or more workflows may be loaded onto the User Computer 5 or reside on a remote computer accessible by the user.

According to embodiments of the present invention, the workflows may be created in the following ways: 1) the Workflow Manager 20 may create the workflows; and/or 2) a third party provider (i.e., an aggregator or bundle builder) may create the workflows.

According to an embodiment of the present invention, the one or more workflows may interact with the one or more associated bundles in a number of ways, including but not limited to: 1) controlling and/or impacting the presentation of the bundle to the User Computer 5; 2) updating, changing, or amending any state information maintained by the bundle and/or the computing resources of the bundle; 3) determining which computing resources of the bundle are accessible by the User Computer 5; and 4) controlling how the one or more computing resources may be used.

The Workflow Manager 20 permits the users to initiate or launch the one or more desired workflows via a direct initiation, an external event, upon subscription to the workflow, and/or upon subscription to a bundle containing or associating with the workflow. As such, the workflows may be associated with the act of obtaining the rights to use or the use of the computing resources related to a specific task (ice., a bundle). Workflows may also be associated with the act of providing user profile data required to support a workflow. Specifically, the act of acquiring a workflow may be used to compel the user to provide required profile data. The act of providing such data may itself require the supervision of a workflow so as to insure all appropriate and required data is gathered and stored for later use.

In addition, the workflow may be configured to receive and respond to state information related to one or more bundles, the computing resources of a bundle, a user profile (described below in detail), and one or more other workflows. Furthermore, the workflow may be configured to interact with the User Computer 5 in any suitable fashion, including but not limited to via a suitable application (e.g., an application which is independent form or part of a bundle), a Web-based portal, electronic communications (e.g., e-mail), or a combination thereof

The Workflow Manager 20 is configured to treat the one or more workflows as ‘objects,’ which may be searched for and bundled in a manner consistent with the treatment of conventional computing resources. In this regard, the one or more workflows may be created, advertised, searched for, obtained, and or subscribed to like a conventional computing resource. In order to establish object-like workflows, the Workflow Manager 20 utilizes a standardized means for describing the workflows, in order to facilitate searching and identification of workflows by a User Computer 5 or third party aggregator (i.e., a builder of one or more bundles) via the Search Engine 15. Furthermore, the Workflow Manager 20 is configured to establish a means by which one or more workflows, or a reference to the workflows, may be included in a bundle.

According to an embodiment of the present invention, the Workflow Manager 20 is configured to interact with the Bundle Manager 10 to associate the one or more workflows with the one or more related bundles, to form one or more workflow-enhanced bundles. The workflow may be contained within or referenced by a bundle. The association of the workflow and related bundle allows the workflow to signal its state to the bundle, thereby causing the bundle to change its presentation to the user. In addition, the user's interaction with a bundle may be communicated to the workflow to allow the workflow to update accordingly.

The Provisioning System i further comprises an Identity Manager 30, which is communicatively connected to one or more of the User Computer 5, one or more third party providers, the Bundle Manager 10, the Search Engine 15, and the Payment Manager 50. The Identity Manager 30 is a computer-executable program and/or hardware module configured to create, store, maintain, and manage one or more user profiles. A “user profile” includes information related to the user, including but are not limited to a user name or login, password, credentials, authorization levels, information related to the user's system, historical transaction data (i.e., subscriptions), billing information (i.e., credit card account information, billing address, etc.).

According to an embodiment of the present invention, the user profile may be created, described and defined in a standardized manner. The standardized format of the user profiles allows them to be registered with the Search Engine 15, and searched for by third party providers.

The Identity Manager 30 is configured to support a user seeking to authenticate himself or herself in order to access, interact with, and/or use the computing resources of a bundle. According to an embodiment of the present invention, at the request of the User Computer 5, the Identity Manager 30 may provide the Bundle Manager 10 with user profile information necessary to gain access to a bundle or one or more computing resources comprised therein for which the user previously subscribed or wishes to subscribe to. In addition, the one or more user profiles may be communicated by the Identity Manager 30 to the Bundle Manager 10, wherein the Bundle Manager 10 may include the one or more user profiles in a related bundle.

According to an embodiment of the present invention, the user profile interact with and be affected by a bundle. This may be achieved by sending the user a request for information required by the user profile, either upon installation of the bundle, launch of the bundle, and/or the user of any of the computing resources of the bundle. The request for required user information may be presented via a GUI interaction with the user(e.g., via an application which queries the sue for data) and/or a non-GUI interaction with the user(e.g., via an e-mail form which queries the user for data). Optionally, the request for the user information may be made to a third party source acting on the user's behalf. The user profiles may be stored according to any suitable method and/or device, and may be stored at a location (ergo, the User Computer 5 or a remote storage location) selected by the user or on behalf of the user.

According to an embodiment of the present invention, the user profiles may be stored locally for off-line access by the User Computer 5, or remotely relative to the User Computer 5, wherein the user profile is provided to the User Computer 5 in response to a request for said information. The ability of the Identity Manager 30 to support a manage the user profiles is independent of the location of storage of the profiles (i.e., local or remote).

According to an embodiment of the present invention, the Identity Manager 30 manages and controls access to the one or more user profiles by the one or more third parties. As such, one or third party providers must interface with the Identity Manager 30 in order to gain access to the one more user profiles maintained by the Identity Manager 30. The user profiles may be accessed by one or more third parties according to access privileges defined by the user and integrated into the user profile. Optionally, the Identity Manager 30 may present access to the one or more user profiles as an application, service or bundle to which the third party provider is required to “subscribe” to gain access. Access to a user profile is controlled by that specific user. Specifically, the user may choose the level of control he or she wishes to have over access to his or her user profile by one or more third party providers. For example, the user may elect to maintain minimum control over access to his or her user profile, thereby permitting all inquires from third party providers for the user profile to be fulfilled. Alternatively, the user may elect to maintain maximum control over access to his or her user profile, thereby requiring tat all requests received from a third party provider would have to be reviewed and approved by the user prior to fulfillment.

According to an embodiment of the present invention, the Provisioning System 1 comprises a Task Profile Manager 40, which is communicatively connected to one or more of the User Computer 5, one or more third party providers, the Bundle Manager 10, the Search Engine 15, and the Payment Manager 50. The Task Profile Manager 40 is configured to create and manage one or more task profiles. A task profile is a collection of information related to the performance of a task, and may include but is not limited to the state of the task, the status of the task, information related to the use of a bundle, information related to the use of one or more of the computing resources, information related to the use of a workflow, etc. The Task Profile Manager 40 collects the information comprised in the task profile based on the user's interaction with the bundle directed to that task. In this regard, the task profile information is collected at the initiation of the user, an external event, upon subscription to a profile, at the request of a bundle, or at the request of a computing resource contained within a bundle.

Whenever a user is prompted to provide task profile information, that content may be stored on by the Task Profile Manager 40. The selection as to which Task Profile Manager(s) 40 to use for this purpose is driven by the logic governing the capture of user profile data in the first place. The authentication and authorization of the user's rights and limits to store task profiles on a Task Profile Manager 40 may be performed in a variety of fashions including, but not limited to any commercially used or proprietary means of achieving such identity validation and the negation of storage and access privileges. In addition to user-initiated events requiring the creation of a task profile (such as the acquisition of a bundle), one or more external events may trigger the collection of data for a task profile, including but not limited to a 3^{rd} party offer, the expiration of a subscription or license, an attempt by an external party to engage the user in a particular kind of interaction or transaction, or an automated process seeking to update previously submitted data.

The Identity Manager 30 and the Task Profile Manager 40 are configured to store the user/task profiles in a secure, accessible manner, using any suitable method or format (e.g. XML). The Identity Manager 30 and the Task Profile Manager 40 allow the one or more user profiles and task profiles to be represented as ‘objects,’ which may be searched for and otherwise grouped with related computing resources into a bundle. According to an embodiment of the present invention, the Identity Manager 30 and the Task Profile Manager 40 are configured to establish a standardized means of describing a user/task profile so that the profile may interact with and be affected by a bundle.

According to an embodiment of the present invention, the Identity Manager 30 and the Task Profile Manager 40 are configured to interact with the Bundle Manager 10. The Identity Manager 30 interacts with the For example, if a bundle requires certain task/user profile information in order to use the bundle, an automatic request for the required information

According to an embodiment of the present invention, the Identity Manager 30 and Task Manager 40 may be configured to interact with the Workflow Manager 20. The interaction between the workflow(s) and user/task profiles is facilitated by establishing a standardized or uniform means by which the workflow may request, gain access to, and modify data within the user/task profiles. In this regard, the workflows may gain access to, read, and/or modify a user/task profile contained within or referenced by one or more of the following: 1) the same bundle(s) in which the workflow is contained; and 2) a different bundle(s) to which the user previously subscribed.

In addition, the Provisioning System 1 may be configured to allow a third party provider maintaining a user's workflow to request and gain access to one or more user profile(s), by, for example, providing the workflow with the required access privileges. According to an embodiment of the present invention, this is achieved is maintained to be requested and accessible

The Identity Manager 30 may be configured to allow a user to establish his or her user profile in support of requests made by that user to search for and/or subscribe to a bundle, make use of the computing resources or workflows of that bundle. In addition, the Identity Manager 30 may interact with the Payment Manager 50 to pay or receive payment for such access and use.

The Identity Manager 30 further allows the user to provide a third party or respond to a request to provide to a third party the rights to access his or her user profile. In addition, the Identity Manager 30 is configured to: 1) stores user credentials, 2) manages the credentials, 3) respond to one or more requests for access rights received from one or more third parties, and 4) interact with the user in response to said requests. These services (e.g., the requesting of access by a third party to a user profile) may be performed in a store-and-forward manner, wherein a user s prior authorization permitting access to the user profile is kept on file and available for fulfillment of third party requests when the user's system is not accessible.

According to an embodiment of the present invention, the Provisioning System 1 includes a Search Engine 15. The Search Engine 15 is a computer-executable program configured to allow a User Computer and/or third party provider to search for and gain access to one or more components of the Provisioning System 1. The User Computer 5 interacts with the communicatively connected Search Engine 15 to locate one or more of following elements: 1) a bundle; 2) a workflow; 3) a user profile; 4) a task profile; 5) user payment information; and/or 6) a computing resource.

As shown in FIG. 1, the Bundle Manager 10, the Workflow Manager 20, and the Identity Manager 30 are each communicatively connected to the Search Engine 15 and configured to provide the Search Engine 15 with one or more bundles, workflows, and user profiles, respectively, upon receipt of a request or search initiated by a User Computer 5 or third party provider. One having ordinary skill in the art will appreciate that the User Computer 5 and/or third party provider(s) may interface with the Bundle Manger 10, the Workflow Manager 20, the Identity Manager 30, the Task Profile Manager 40 and/or the Payment Manager 50 directly or via the Search Engine 15. Furthermore, one having ordinary skill in the are will appreciate that use of the Search Engine 15 to identify, locate and interface with the components of the Provisioning System 1 is optional, accordingly, the Search Engine 15 is depicted with a dashed line in FIG. 1. In addition, it is to be appreciated that the Search Engine 15 may reside either locally (on the same computer) or remotely (on a separate computer) relative to the Provisioning System 1.

According to an embodiment of the present invention, the Provisioning System 1 comprises a Payment Manager 50 configured to manage and process payment for the services related to use and interaction with the Provisioning System 1. The Payment Manager 50 is a computer-executable program and/or hardware module configured to facilitate payment by a user and/or third party provider using the Provisioning System 1, such as, for example, the access and/or subscription to a workflow, a bundle, a workflow-enhanced bundle, a user profile, a computing resource, a task profile, and/or a combination thereof

The Payment Manager 50 is adapted to support any suitable payment methods, such as, for example, conventional credit or debit card processing. The Payment Manager 50 may process payment by a user according to one or more of the following methods: 1) a one-time payment; 2) a subscription-based payment; 3) a use-invoked subscription; 4) usage-based payment; 5) payment based on resource metering; and/or 6) redemption by the user of credits accrued based on the user's viewing of advertising (e.g., banner placement, surveys, referrals to other users).

The Payment Manager 50 may be configured to authorize a third party provider to automatically debit/credit a user's account based on the user's activity. The authorizations are generally limited to a prescribed range of funds and/or time, which may be set by the user. For example, a third party provider may request the right to debit and/or credit the user's account, in a particular fashion (e.g., as a one-time event, on a re-occurring basis, based on usage, etc.). Furthermore, the third party provider may request the right to debit and/or credit the user's account on behalf of another party. For example, a bundle aggregator may serve as a financial intermediary between the providers of the computing resources contained in the bundle and the bundle subscribers (i.e., the users). The Payment Manager 50 may be integrated with the Identity Manager 30 to enable user's to establish pre-authorizations, whereby a third party provider request for rights to debit and/or credit the user's account may be automatically fulfilled/approved.

### EXAMPLE

FIGS. 2-5 illustrate an example of the present invention, particularly exemplary interfaces as seen by a User Computer 5 interacting with the Provisioning System 1, according to an embodiment of the present invention. As shown in FIG. 2, the User Computer 5 is presented with a GUI interface which presents the available bundles (the EZ Car Sales bundle 11, the Auto Ad Manager bundle 12 and the Car Sales Guide bundle 13) which the user may select and subscribe to, along with a window providing a description related to the bundles.

In this example, the user selects the EZ Car Sales bundle 11, which is launched and presented to the user via the exemplary interface illustrated in FIG. 3. As shown in FIG. 3, the EZ Car Sales bundle 11 is comprised of the following computing resources: a user profile 14 captioned “My Profile”; a number of computing resources 15 captioned as follows: “Auto Ad Composer,” “Post Ads With Garnet,” “Useful Legal Documents,” “Electronic Notary,” “Update The DMV,” and “Update Insurance”; and a workflow 16 captioned “Guide Me.”

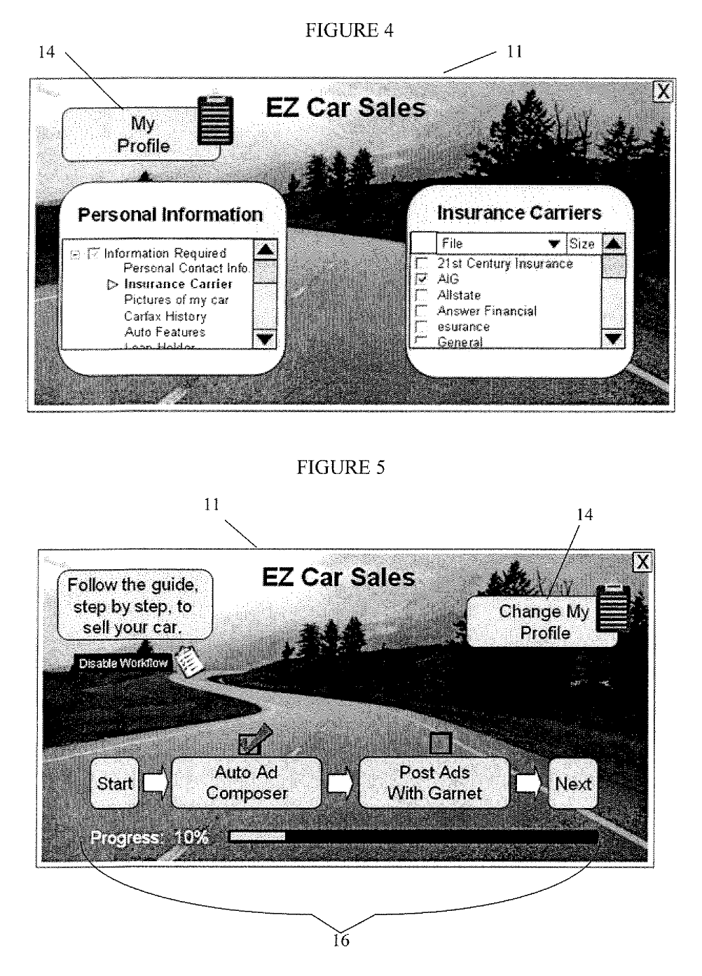

In the example, the user accesses or launches the user profile 14 captioned “My Profile” and is presented with the exemplary GUT illustrated in FIG. 4. As shown in FIG. 4, the user is able to create his or her user profile by interacting with the “Personal Information” window and related side window (e.g., the “Insurance Carriers” window).

In this example, upon completion of the user profile 14, the user is again presented with the GUI illustrated in FIG. 3, where the user launches the workflow 16 captioned “Guide Me” and is presented with the GUI illustrated in FIG. 5. FIG. 5 illustrates a workflow 16 in use. As shown, a portion of the steps for navigating the EZ Car Sales bundle 11 are displayed to the user. Optionally, a “progress” bar may be provided to provide the user with an indication as to the percent

It is to be understood that the exemplary embodiments and the above example are merely illustrative of the present invention and that many variations of the above-described embodiments and example can be devised by one skilled in the art without departing from the scope of the invention. It is therefore intended that all such variations be included within the scope of the invention.

What is claimed is:

1. A method for provisioning computing resources to a users the method comprising the steps of:
aggregating at least two computing resources related to a task into a bundle, wherein the bundle may be accessed by the user;
managing a workflow configured to direct the user's execution of the task;
associating the workflow and the bundle to form a workflow-enhanced bundle; and
providing the user with access to the workflow-enhanced bundle.

2. The method of claim 15 wherein the step of managing the workflow further comprises creating the workflow.

3. The method of claim 2, wherein the step of managing the workflow further comprises receiving the workflow from a third party provider.

4. The method of claim 1, further comprising the step of registering the bundle with a search engine configured to allow a user to search for the bundle.

5. The method of claim 1, further comprising the steps of:
collecting information related to a user of the computing services;
creating a user profile comprising the information; and
adding the user profile to the workflow-enhanced bundle.

6. The method of claim 5, further comprising the step of driving the workflow with the user profile.

7. The method of claim 1, further comprising the steps of:
creating a task profile comprising information related to performance of the task; and
adding the task profile to the workflow-enhanced bundle.

8. The method of claim 5, further comprising the step of releasing the user profile to a provider of at least one of the computing resources of the bundle.

9. The method of claim 1, wherein the bundle comprises the workflow.

10. The method of claim 5, further comprising the steps of:
tracking the user's activity; and
managing the workflow based on the user's activity.

11. The method of claim 1, further comprising the step of registering the bundle with a search engine configured to allow a user to search for the bundle.

12. The method of claim 1, further comprising the step of registering the workflow with a search engine configured to allow a user to search for the workflow.

13. The method of claim 5, further comprising the step of registering the user profile with a search engine configured to allow a computing resource provider to search for the user profile.

14. The method of claim 7, further comprising the step of registering the task profile with a search engine configured to allow a user to search for the user

15. The method of claim 1, further comprising the step of allowing the user to subscribe to at least one of the bundle, the workflow, and the workflow-enhanced bundle.

16. The method of claim 5, further comprising the step of allowing a third party provider to access the user profile.

17. A system for provisioning a plurality of computing resources to a user comprising:
a bundle manager configured to aggregate at least two computing resources related to a task into an at least one bundle; and
a workflow manager communicatively connected to the bundle manager, wherein the workflow manager associates at least one workflow with the at least one bundle to form a workflow-enhanced bundle.

18. The system of claim 17, further comprising an identity manager communicatively connected to the bundle manager, wherein the identity manager is configured to:
create a user profile comprising information related to the user; and
associate the user profile with the workflow-enhanced bundle

19. The system of claim 18, further comprising a search engine communicatively connected to the bundle manager, the identity manager and the workflow manager, wherein the search engine is accessible by at least one of the user and a third party provider and configured to facilitate searching for at least one of the user profile, the at least one bundle, and the at least one workflow.

20. The system of claim 17, wherein the workflow manager is configured to allow the user to subscribe to the at least one workflow.

21. The system of claim 17, wherein the bundle manager is configured to allow the user to subscribe to the at least one workflow-enhanced bundle.

22. The system of claim 17, wherein the workflow manager and the identity manager interact to facilitate the use of the user profile to determine work flow to determine

23. The system of claim 17, wherein the workflow manager creates the workflow.

24. The system of claim 17, wherein the workflow manager receives the workflow from a third party provider.

25. The system of claim 17, wherein the identity manager is configured to release the user profile to a third party provider.
